(19) United States
(12) Patent Application Publication
(10) Pub. No.: US 2025/0104065 A1
(43) Pub. Date: Mar. 27, 2025

(54) METHOD FOR PROCESSING A TRANSACTION, SYSTEM AND CORRESPONDING PROGRAM

(71) Applicants: WORLDLINE, PUTEAUX (FR); INGENICO BELGIUM, BRUXELLES (BE)

(72) Inventors: Guillaume Lefebvre, Meurchin (FR); Olivier Mery, Hellemmes (FR); Mark Vanophalvens, Meerbeek (BE)

(21) Appl. No.: 18/728,730

(22) PCT Filed: Jan. 13, 2023
(86) PCT No.: PCT/EP2023/050739

§ 371 Date: Jul. 12, 2024

(30) Foreign Application Priority Data
Jan. 14, 2022 (FR) FR22/00281

(51) Int. Cl. G06Q 20/40

(52) U.S. Cl. CPC G06Q 20/401

(57) ABSTRACT

A method for processing a transaction of the type in which a user supplies a sensitive data item on a digital terminal. Such a method includes: initiating, using the digital terminal, a transaction requiring the input of the sensitive data item; after the initiation, obtaining, by using an image capture device connected to the terminal, a multimedia data item representative of an environment of the user; analyzing the multimedia data item previously obtained; and modifying a context for implementing the transaction when the analyzing the multimedia data item outputs a result that is representative of a non-secure environment.

### 1. FIELD

The invention relates to the field of security of transactions. More particularly, the invention relates to the security of transactions, involving the entry, by a user, of sensitive information on an entry device. The invention aims more particularly to secure such an entry.

### 2. PRIOR ART

The digitalization of the economy and the explosion in the use of digital technologies has radically changed our lives. In particular, the use of increasingly intelligent communication terminals has certainly opened up new possibilities for interaction with many institutions and many services while increasing security risks. Among the posed security problems, that of the theft of sensitive information constitutes a threat that is difficult to counter. Indeed, it is very common to have to enter, on a digital device, for example public, sensitive data (credit card number, PIN code, account number, etc.) which fraudsters are fond of. To be able to read this data entered without the user's knowledge, two techniques are mainly implemented: the first technique consists of inserting, in the digital terminal, one or more spyware, the objective of which is to recover sensitive data entered by the user to transmit them to fraudsters through the communication networks to which the digital device is connected. The second, simpler technique consists of spying on the inputs made by the user. This technique is called «Shoulder Surfing».

To prevent these spying problems, one technique may be the use of a privacy film to ensure that the terminal screen may only be seen clearly when the line of sight and the screen are in one certain angle range using optical principles. But with this technique, there is no way to avoid spying from a viewing angle close to that of the legitimate user. In addition, the privacy film affects the brightness of the screen and it is up to the user to ensure that it is in good conditions of use.

It is therefore necessary to provide complementary systems and techniques which make it possible to preserve the confidentiality of the information displayed on the screen of the device while reducing the disadvantages of the prior art.

### 3. SUMMARY

The technique designed by the inventors was tested to respond at least in part to the problems posed by the prior art. Thus, the present disclosure relates to a method for processing a transaction of the type comprising the provision, by a user, of sensitive data on a digital terminal. Such a method comprises:
a step of initializing by the digital terminal a transaction requiring the entry of sensitive data;
a step of obtaining, after initialization, through an image pickup device connected to the terminal, multimedia data representative of the user's environment;
a step of analyzing the multimedia data previously obtained; and
a step of modifying an implementation context of the transaction when the step of analyzing the multimedia data delivers a result representative of an insecure environment.

Thus, it is possible to take into account the user's environment to estimate whether or not the latter can safely enter sensitive data.

According to a particular characteristic, the analysis step comprises:
a step of searching, within the multimedia data, for a set of at least one face;
when the number of faces is greater than or equal to two, a step of providing the result representative of an insecure environment.

Thus, the disclosure makes it easier to segregate risky situations, in which several faces are detected, to estimate the level of security of the user's environment.

According to a particular characteristic, the analysis step comprises:
a step of searching, within the multimedia data, a set of at least one face;
when the number of faces is equal to one, a step of searching, within the detected face, an orientation of the eyes of the detected face; and
when the orientation of the eyes of the detected face indicates that the user is not looking at the terminal screen, a step of providing the result representative of an insecure environment.

Thus, it is possible to determine whether the user is actively focused on the task of entering the sensitive data, in order to trigger, for example, the hiding of the screen when the user is not looking at it.

According to a particular characteristic, the obtaining step comprises a step of obtaining, from sensors of the digital terminal, at least one data representative of the radio environment of the digital terminal and the analysis step comprises, when the data representative of the environment is not in compliance with an expected value, a step of providing the result representative of an unsecured environment.

Thus, the technique takes into account not only the data coming from the visual sensor, but also changes in the radio environment, which can represent premises for a coordinated attack, consisting for example of spying on the entry of the user and of obtaining digital data from the digital terminal with the aim of combining the data from the electric radio attack with those obtained by spying on the user. Furthermore, the analysis of the radio environment associated with the analysis of the visual environment makes it possible to respond to the orientation constraints of the camera. Indeed, the analysis of the radio environment makes it possible to not limit the secure environment to the field of vision of the camera. In combination with the analysis of the multimedia data, the entire environment of the terminal is secure, whether the risk is in the field of vision of the image pickup device or not.

According to a particular characteristic, the analysis step comprises, when the data representative of the radio environment is in conformity with said expected value, said step of searching, within the multimedia data, for a set of at least one face.

Indeed, it is preferable to first ensure that the terminal is not under computer attack, and only then to check the visual environment. This is the optimal strategy.

According to a particular characteristic, the step of modifying the implementation context of the transaction comprises:
a step of displaying, to the user, a warning message relating to the detection of the insecure environment;
a step of alerting a manager of the terminal;
a step of hiding at least one information displayed on the screen of the terminal; and/or
a step of blocking a sensitive data entry area

According to a particular characteristic, the step of modifying the implementation context of the transaction further comprises a step of displaying, to the user, a warning message relating to the detection of the unsecured environment.

According to a particular characteristic, after the step of displaying the warning message relating to the detection of the unsecured environment, the method comprises, a step of receiving, by the digital terminal, data representative of acceptance, by the user, of the continued entry of the sensitive data.

According to a particular characteristic, the step of modifying an implementation context of the transaction comprises, when at least two faces are detected within the multimedia data:
step of calculating biometric characteristics of at least one among the at least two detected faces; and
a step of updating, within the terminal itself, or a device connected to the terminal, a database of detected face characteristics.

Thus, it is possible to keep occurrences of detected faces to perform a correlation of the detected faces with the aim of identifying the most frequent occurrences.

According to a particular characteristic, the step of updating a database of detected face characteristics comprises a search, within the database, for composite identifiers of face characteristics corresponding to the characteristics calculated for a current face, and, when such data are already present in the base for the current face, a step of incrementing a counter relating to these characteristics for this current face.

Thus, it is possible to count the appearances of a face, and to detect a face which appears abnormally often (potentially a lurker).

According to a particular characteristic, the step of modifying the implementation context of the transaction comprises:
when the data representative of the radio environment does not conform to an expected value, or when the counter associated with the characteristics calculated for a current face exceeds a predetermined ceiling, the step of alerting the terminal manager;
when the orientation of the eyes of the detected face indicates that the user is not looking at the terminal screen, or when the number of faces is greater than or equal to two, the step of hiding at least one information displayed at the terminal screen; and
when the number of faces is greater than or equal to two, the step of displaying, to the user, a warning message relating to the detection of the insecure environment and/or the step of blocking a sensitive data entry area.

According to another aspect, the invention also relates to a digital terminal suitable for processing a transaction of the type comprising the provision, by a user, of sensitive data on the digital terminal. Such a terminal comprises:
means for initializing by the digital terminal a transaction requiring entry of sensitive data;
means for obtaining, after initialization, through an image pickup device connected to the terminal, multimedia data representative of the user's environment;
means for analyzing the multimedia data previously obtained; and
means for modifying a context of implementation of the transaction when the means of analyzing the multimedia data deliver a result representative of an insecure environment.

According to a preferred embodiment, the different steps of the methods according to the present disclosure are implemented by one or more software or computer programs, comprising software instructions intended to be executed by a data processor of an execution terminal according to the present technique and being designed to control the execution of the different steps of the methods, performed at a communication terminal, a remote server and/or a blockchain, within the framework of a distribution of processing to be performed and determined by scripted source code or compiled code.

Consequently, the present technique also targets programs, capable of being executed by a computer or by a data processor, these programs including instructions for controlling the execution of the steps of the methods as mentioned above.

A program may use any programming language, and be in the form of source code, object code, or intermediate code between source code and object code, such as in a partially compiled form, or in any other desirable shape.

The present technique also targets an information medium readable by a data processor, and including instructions of a program as mentioned above.

The information carrier can be any entity or terminal capable of storing the program. For example, the carrier may include a storage means, such as a ROM, for example a CD ROM or a microelectronic circuit ROM, or even a magnetic recording means, for example a mobile medium (memory card) or a hard drive or an SSD.

On the other hand, the information carrier may be a transmissible medium such as an electrical, optical and/or sound signal, which may be conveyed via an electrical or optical cable, by radio or by other means. The program according to the present technique can in particular be downloaded over an Internet type network.

Alternatively, the information carrier may be an integrated circuit in which the program is incorporated, the circuit being adapted to execute or to be used in executing the method in question.

According to an exemplary embodiment, the present technique is implemented by means of software and/or hardware components. With this in mind, the term «module» may correspond in this document to a software component as well as to a hardware component or to a set of hardware and software components.

A software component corresponds to one or more computer programs, one or more subprograms of a program, or more generally to any element of a program or software capable of implementing a function or a set of functions, as described below for the concerned module. Such a software component is executed by a data processor of a physical entity (terminal, server, gateway, set-top-box, router, etc.) and is capable of accessing the hardware resources of this physical entity (memories, recording media, communication buses, electronic input/output cards, user interfaces, etc.).

In the same way, a hardware component corresponds to any element of a hardware assembly capable of implementing a function or a set of functions, according to what is described below for the concerned module. It may be a programmable hardware component or one with an integrated processor for executing software, for example an integrated circuit, a smart card, a memory card, an electronic card for executing a firmware, etc.

Each component of the system previously described obviously implements its own software modules.

The different embodiments mentioned above may be combined with each other for the implementation of the present technique.

### 4. DRAWINGS

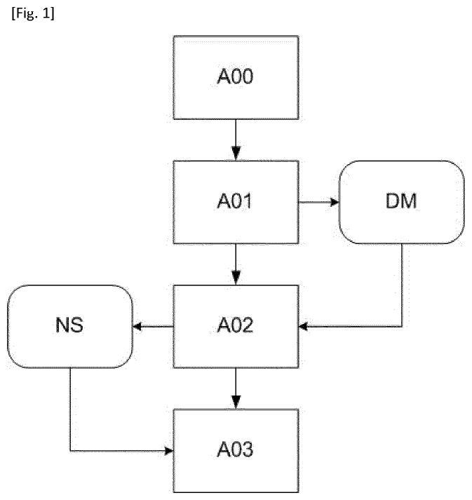

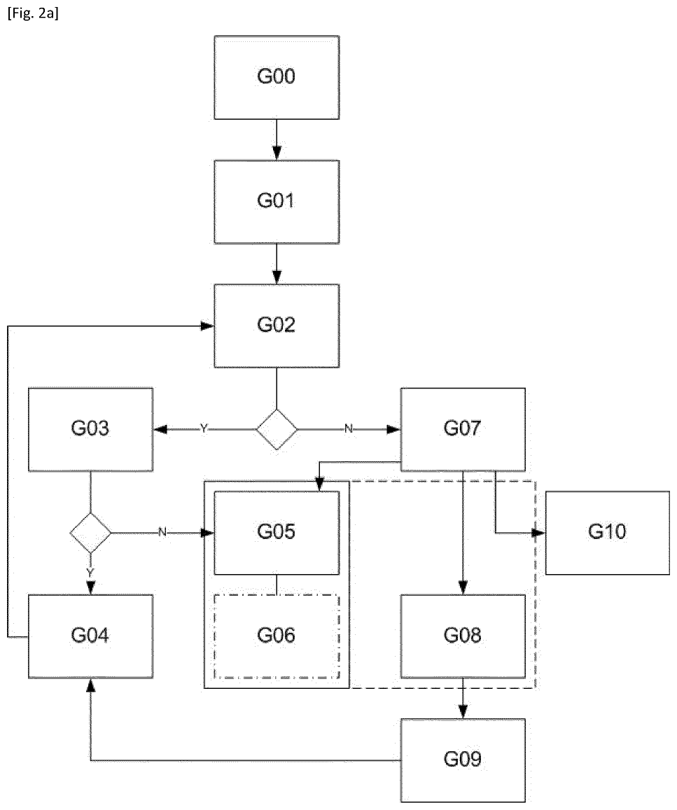

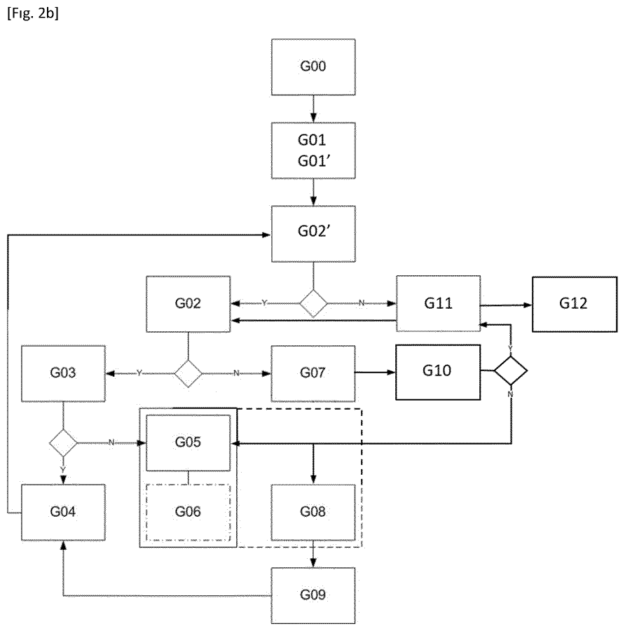

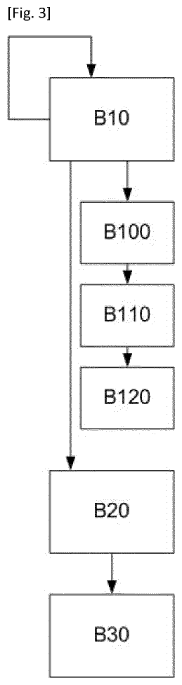

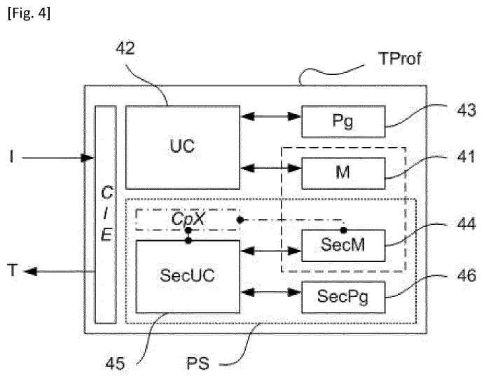

Other aims, characteristics and advantages of the invention will appear more clearly on reading the following description, given by way of a simple illustrative and non-limiting example, in relation to the figures, among which:

[FIG. 1] represents the implemented general principle;

[FIG. 2a] represents an exemplary embodiment of the transaction processing method;

[FIG. 2b] represents an exemplary embodiment of the transaction processing method;

[FIG. 3] represents the image characteristic extraction method;

[FIG. 4] represents a simplified physical architecture of a device in which the methods previously described may be implemented.

### 5. DESCRIPTION

### 5.1. Reminders of the Principle

The general principle of the invention, in a terminal on which an entry is performed as part of a transaction, consists of processing visual information coming from a front sensor of the terminal to determine whether or not the user can, enter sensitive data. To do this, we determine if the user is attentive to the information displayed on the terminal screen and/or if he is alone in front of the terminal to be able to enter this sensitive data (PIN, password, etc.).

Among the devices often used to entry sensitive information, payment terminals are considered secure because they are used to process payments. The new terminals can also be used for other purposes, depending on the merchant's business analysis. Thus, the terminal may be used to execute value-added services or commercial applications on which personal information may be requested. Even if the data provided to the terminal is processed securely in the terminal itself, one cannot be sure that the user is not being spied on when entering their personal data. For example, entering a PIN code is a critical step during a payment transaction at a payment terminal. During this entry phase, the attacker looks over the user's shoulder to see what digits are entered when entering the pin. Thanks to the implemented technique, we proactively signal to the user, the customer or even the merchant that the surrounding physical context is potentially risky, in order to allow them to make the decision whether or not to continue data entry. For a payment, the processing of the transaction can be automatically stopped when a change in the environment surrounding the terminal (for example the payment terminal) is noted. When entering on a user communications terminal, the transaction may also be stopped, or the screen may be hidden.

Thus, generally speaking, in relation to FIG. 1, the invention concerns a method for processing a transaction of the type comprising the provision, by a user, of sensitive data on a digital terminal. According to the invention, such a method comprises:
a step of initializing (A00) by the digital terminal a transaction requiring the entry of sensitive data;
a step of obtaining (A01), after initialization (A00), through an image pickup device connected to the terminal, multimedia data (DM) representative of the user's environment;
a step of analyzing (A02) the multimedia data (DM) previously obtained; and
a step of modifying (A03) an implementation context (or “execution context”) of the transaction when the step of analyzing the multimedia data (DM) delivers a result representative of an unsecured environment (NS).

Depending on the operational implementation conditions, the processing method is operated using a 2D or 3D camera as an image pickup device. Sensors integrated into the system of the digital terminal can also be used. During the data provision phase of a transaction or payment application, the camera films the user's environment. The payment terminal, on the basis of images from the camera and optionally data from the sensors, analyzes this or these image(s) to try to identify the faces which are visible from the front on the screen of the terminal; optionally the sensors may also check if anything unusual is happening (network changes, WiFi jamming, location changes, etc.). Thus, for example when the payment terminal detects several faces and considers that the environment is risky, it modifies the context of execution of the transaction, for example by warning the customer and/or the merchant that one or more other people can see the data he is about to provide and there is a risk that this data will be stolen. If the risk is considered too high by the terminal, the terminal can modify the context of the transaction by interrupting the interaction (the payment PIN code entry phase for example) or by automatically abandoning the transaction (without action from the user). It can also warn the merchant of a potential fraudulent act that could occur within his business. In addition, as explained below, it is possible to store biometric characteristics of detected faces, when these characteristics are frequently recognized, it is possible to alert the security of the merchant in real time (in addition to the warning on the POS screen), for example for video protection purposes. To avoid false positives, a white list of faces that the digital terminal could recognize (such as for example faces on signs or posters, in a store or at the user's home when the method is implemented on a personal communication terminal of a user) is implemented and thus makes it possible to avoid unexpected alerts on the screen. This technology also makes it possible to improve the security of the store or point of sale thanks to a “local” analysis (in the point of sale) which complements the video surveillance of the store. Thus, the camera (and the module) which captures the multimedia data and which provides the images (or the characteristics extracted from the images) to the digital terminal is not necessarily integrated into the terminal itself. This may involve one or more video surveillance cameras positioned to allow the capture of faces on the one hand and the position of one or more people within the store, for example.

### 5.2. Implementation of the Transaction

We present, in relation to FIG. 2a, the general method implemented for conducting a transaction, according to the present disclosure, in the situation where a front sensor of a digital terminal is used. This general processing method comprises:
the initialization (G00) of a transaction, involving the entry of sensitive data;
the activation (G01) of the sensor of the terminal and
the execution (G02) of a module for detecting and extracting image characteristics from this sensor; this module provides at least one indication of a number of faces present in the image sensed by the sensor;

an analysis step, by an environment analysis module, comprising:
when a single face is detected (Y), a step of determining (G03) an orientation of the face and/or eyes of the face detected within the image;
when the face and/or eyes are determined to be correctly oriented (Y), a display step (G04), on the terminal screen, of the fields and information necessary for entering the sensitive data;
when the face and/or eyes are determined to be incorrectly oriented (N), a step of changing the execution context comprising a step of hiding (G05) the information displayed on the screen of the terminal and/or blocking (G06) the form for entering such information as long as the face and/or eyes are determined to be incorrectly oriented (N);
when several faces are detected on the image (N), an execution context change step comprising a step of calculating (G07) biometric characteristics of at least one among the plurality of detected faces, a step of hiding (G05) information displayed on the screen of the terminal and/or blocking (G06) the form for entering such information and a step of displaying (G08) a message to the user;
when the user indicates (G09), for example by pressing a key on the terminal or an element on the screen, that the context in which he finds himself is conducive to entering the sensitive data, the step of displaying (G04), at the terminal screen, the fields and information necessary for entering the sensitive data is performed.

In addition, following the calculation (G07) of (biometric) characteristics of at least part of the plurality of detected faces, the method can comprise an updating step (G10), either within the terminal itself, or from a device or server connected to the terminal, from a database of detected face characteristics. This update step comprises in particular a search, within the database, for composite identifiers of facial characteristics corresponding to the characteristics calculated for a current face, and when such data are already present in the database for the current face, a step of incrementing a counter relating to these characteristics for this current face; when it is detected that it is a new face (absence of the characteristics of this face in the database) a new record is created relating to this new face. In addition to the (biometric) characteristics of this supernumerary face which is detected, a portion of the image comprising this supernumerary face is also stored in the database. Furthermore, if it happens that facial characteristics are detected too frequently (i.e. the counter associated with these characteristics exceeds a predetermined ceiling), the method may include a step of transmitting, by the terminal or the device to which it is connected (server), a message indicating to the user or merchant (if it is a payment terminal), that the same face is frequently detected within the range of the front sensor of the terminal and that it is necessary to be careful. Depending on legislation, any portions of images stored in the database may also be provided to the user or merchant so that they can more easily recognize the individual to whom this face belongs. Optionally, if the user or the merchant has this frequently recognized face, he can, in the event of a recurring false alert, transmit a response requiring the placement of this face on a white list (for example in the case of a couple frequently captured as a duo on the images in question).

Optionally, the step of hiding (G05) and/or displaying (G08) a message to the user can be supplemented or replaced by a step of broadcasting an audio alert. Such additional information is clever for two reasons: if the user is visually impaired (for a question of accessibility, therefore), he cannot easily know on the one hand what is displayed on the screen and on the other share who are the people who could spy on his screen without his knowledge. Emission of an audible warning solves this problem. In addition, when the user is «distracted» (their eyes are not in the correct orientation), this audible warning causes renewed the user attention, and jointly, of any people who could be the source of the user's distraction, and consequently, for the method described here, causes the possibility of seeing appear, in the following image (step G02), the face of these potentially malicious people.

Optionally, as explained previously, additional data is provided by the terminal's integrated sensors. In particular, the initialization of the transaction causes the execution of the environment analysis module, as indicated previously, and this module comprises, for example, in addition to the means previously described, a radio activity analysis module around the terminal (wireless connection broken, reception of RFID data) and/or for example sudden modification of data from the terminal, such as a change in the location of the latter. When such changes are provided/detected to the environment analysis module, it can modify the execution context of the transaction, as discussed earlier.

Optionally, in addition to face detection, and more particularly the user's face, the analysis step may comprise the analysis of other characteristics of the image itself, such as for example color changes, brightness to the background of the image. Cleverly, as presented in relation to FIG. 3, when such changes in the characteristics of the images themselves are detected, the analysis module may also modify the execution context of the transaction as explained previously. Thus, for example when the image is abnormally light or dark (characteristics obtained using global descriptors of the image), or even when two successive images are substantially identical, the analysis module may also implement the measurements described previously, regardless of whether or not faces are detected within these images.

As the implementation of the method is at least partially iterative, the display and/or control and/or hiding and/or blocking steps are followed by at least one new iteration of the steps described here, as long as the sensitive information are not entered by the user or until a predetermined timer is activated or the user himself cancels the transaction. Thus, in a standard implementation, only some of the steps described above may be performed until the transaction is successful or aborted on the terminal.

### 5.3. Implementation of the Transaction

We present, in relation to FIG. 2b, a preferred embodiment implemented for conducting a transaction, according to the present disclosure, in the situation where in addition a sensor of at least one data representative of the electric radio environment of the digital terminal is used. This processing method comprises, in addition to the steps represented in FIG. 2a:
the activation (G01′) of the sensor of at least one data representative of the electric radio environment (before, after, or at the same time as step (G01));
the execution (G02′) of a module for verifying data representative of the electric radio environment; this module provides at least one indication of whether or not the data representative of the electric radio environment conforms with an expected value. This step is preferably before step (G02) (even if it can possibly be after or at the same time), it is also possible to only perform step (G02) when the data representative of the electric radio environment is in compliance with said expected value, and otherwise when the data representative of the electric radio environment is not in compliance with said expected value, to perform a step (G11) of alerting the manager of the terminal, that is to say of the merchant.

The idea of step (G11) is to inform the merchant that their terminal is potentially undergoing a coordinated attack, and to let them react. It can, for example, carry out a network security analysis to confirm or deny the attack, or query a remote server.

Optionally, the step (G11) is either followed by a return to normal, i.e. performing step (G02), typically if no attack is really confirmed, or on the contrary a step (G12) of blocking the terminal (if the attack is confirmed). It is therefore preferable to start with the radio verifications of step (G02′) because we understand that in the event of an attack, it is useless to look at the faces (step (G02)).

Moreover, as explained, if the step of updating (G10) a database of detected face characteristics comprises, a search, within the database, for composite identifiers of corresponding face characteristics to the characteristics calculated for a current face, and when such data are already present in the base for the current face, a step of incrementing a counter relating to these characteristics for this current face; then step (G10) may comprise the comparison of the counter associated with the characteristics calculated for a current face (and preferably each current face) with a predetermined ceiling.

Then, optionally the step of alerting (G11) the manager of the terminal can be performed when said counter associated with the characteristics calculated for a current face exceeds a predetermined ceiling.

In fact, the merchant can react, in particular try to identify the face frequently detected within the range of the front sensor of the terminal, and either notice that it is a false alert and resume the method, or notice that it is a malicious lookout and block the terminal (step (G12)) for example until the police intervene.

Otherwise, i.e. when said counter associated with the characteristics calculated for a current face does not exceed said predetermined ceiling, it is possible, as explained previously, to modify the context of implementation of the transaction by performing steps (G05), (G06) and/or (G03). In particular we can:
perform the step (G05) in the event of a user not looking at the screen of the terminal (following step (G03)),
perform steps (G08) and (G06) in the case of a plurality of faces detected but a counter associated with the characteristics calculated for a current face not exceeding the predetermined ceiling (following step (G10)).

### 5.4. Description of an Exemplary Embodiment

FIG. 3 is a flowchart showing an example of a method for iterative processing of images acquired according to an exemplary embodiment of the present disclosure. Such a method can be implemented in addition to, instead of or in combination with the method described in FIG. 1 and FIG. 2. This method aims to continuously compare images with each other. It allows, just as in FIG. 1 or FIG. 2, to detect the presence or absence of faces, but in a more analytical way. As presented in FIG. 3, the method comprises:
at least one iteration of a step of processing (B10) an image coming from a sensor (of the terminal or another sensor), comprising:
obtaining (B100) an image coming from the sensor;
detecting (B110) at least one current element within the image;
a step of temporary storing (B120) at least one characteristic of said at least one current element;
an optional comparison step (B20), within said at least one characteristic stored in memory relating to the detected elements, so that the characteristics of the elements detected during a current iteration are compared with the characteristics of the elements detected during a subsequent iteration, said comparison step providing as a result data representative of the differences between characteristics of elements of the current iteration and of the subsequent iteration; and
when the data representative of the differences between characteristics of elements of the current iteration and of the subsequent iteration differ by one or more predetermined ceilings or thresholds, a change in implementation context of the transaction comprising a step of performing (B30) a transaction protection measure conducted by the terminal.

According to an exemplary embodiment of the present disclosure, the detection of the current elements within the image may comprise the detection of one or more faces, of one or more image components, of one or more image backgrounds. Thus, the characteristics measured in the different iterations (at least two) make it possible to segregate (partition) the images. For example, the step of detecting (B110) at least one current element within the current image (i.e. the image acquired in the current iteration) may comprise:
an optional step of calculating, on the current image, a set of descriptors of the current image: for example calculation of one or more global descriptors (histogram, dominant color, CCV) and/or one or more several local descriptors (Harris, SIFT);
a step of detecting a face qualified as main (i.e. the dominant face in the image);
an optional step of obtaining biometric characteristics of the main face, comprising in particular a step of obtaining an orientation of the face and a step of obtaining an orientation of the eyes of the face;
a step of extracting, from the main face, an image background (i.e. portion of the image which does not comprise the detected dominant face);
an optional step of calculating, on the image background, a set of descriptors of the current image: for example calculation of one or more global descriptors (histogram, dominant color, CCV) and/or one or more local descriptors (Harris, SIFT) of the image background;
a step of detecting, on the image background, one or more additional faces;
an optional step of extracting biometric characteristics from each additional face;
an optional step of obtaining biometric characteristics, for all or part of each additional face, comprising in particular a step of obtaining an orientation of all or part of each face and/or a step of obtaining an orientation eyes of all or part of each face.

Thus, using all or part of this information obtained on the extraction of these images, according to an exemplary embodiment of the present disclosure, a face image is acquired when at least one face is extracted from an acquired image, and it is determined that there are one or more additional faces according to the recognition result. At that time, the terminal implements corresponding protection measures according to the embodiments.

In an exemplary embodiment, the face recognition is performed on the acquired image containing at least one human face, and the number of human faces contained in the image is determined. The number of faces contained in the acquired image can be identified according to a face recognition algorithm. In an exemplary embodiment, depending on the number of faces contained in the acquired image, the result of the recognition of the previous image adjacent to the current image is compared to the result of the recognition, if the number of faces contained in the current image is greater than the number of faces in the previous image, the execution context of the transaction is modified. For example, when a user normally uses a mobile terminal, the acquired face image contains only one face of the user. When an additional face is detected next to that of the user, the execution context of the transaction is modified, as explained below.

In an exemplary embodiment, the characteristic information of at least one face image is obtained from the acquired image containing at least one face, and the characteristic information is matched with facial characteristics of the user who performs the operation on the terminal. These characteristics are pre-recorded to perform face recognition (and not just identification). These pre-recorded characteristics can be obtained, by the merchant's payment terminal for example, from either the bank card (for example biometric) used by the user to make their purchase, or from their communication terminal if he uses his mobile terminal (smartphone) to make a payment. In a different context, if the transaction is conducted directly on the user's mobile terminal, the pre-recorded facial characteristics of the user are present within the communication terminal itself of the user and for example stored in a secure element or in a trusted environment.

In a complementary exemplary embodiment, the facial characteristic information of the image obtained from the sensor of at least one face is matched with the pre-recorded facial characteristics of the user. If the facial characteristics of the image obtained from the sensor do not match the facial characteristics of the predetermined user, it is determined that the environment is unsafe or the user is distracted (for example when the eyes of the user are not in the direction of the screen).

In an exemplary embodiment, when it is determined that the environment around the user is not secure or that the user is distracted, the step of blocking the transaction executed by the terminal may for example be one of the following operations, taken alone or in combination: blur the screen, turn off the screen or display an information message. For example, an information message may appear to warn the user that there may be a security issue with their input environment. Advantageously, the information message is displayed above the sensitive data entry field(s) so as to prevent the entry of this data by the user. The screen blurring may cause the writing displayed on the terminal to become blurry and unreadable.

In at least some embodiments, the technique is implemented by using a 3D camera to implement finer detection of the user's environment. This makes it possible to detect whether a real face is behind the first one (not just an image), and may also help to more easily detect the distance at which the possible malicious person is. The distance of the main face in front of the camera can also be used to blur or modify the content of the screen and wait for the user to return if the terminal considers that it is not close enough to interact properly. The 3D camera is also useful for facial recognition itself.

### 5.5. Other Features and Advantages

We present, in relation to FIG. 4, a simplified architecture of a communication terminal, of the payment terminal type (TProf) capable of performing all or part of the processing as presented previously. A communication terminal comprises a first electronic module comprising a memory 41, a processing unit 42 equipped for example with a microprocessor, and driven by a computer program 43. The communication terminal optionally comprises, for security functionalities, such as the generation of cryptographic materials, a second electronic module comprising a secure memory 44, which may be merged with the memory 41 (as indicated in dotted lines, in this case the memory 41 is a secure memory), a secure processing unit 45 equipped for example a secure microprocessor and physical protection measures (physical protection around the chip, by trellis, vias, etc. and protection on the data transmission interfaces, possibly merged with the processing unit 42), and driven by a computer program 46 specifically dedicated to this secure processing unit 45, this computer program 46 implementing all or part of the method for processing a transaction as previously described. The group composed of the secure processing unit 45, the secure memory 44 and the dedicated computer program 46 constitutes the secure module (PS) of the communication terminal. In at least one embodiment, the present technique is implemented in the form of a set of programs partly or entirely installed on this secure portion of the transaction processing terminal. In at least one other embodiment, the present technique is implemented in the form of a dedicated component (CpX) capable of processing data from the processing units and partly or entirely installed on the secure portion of the processing device. Moreover, the device also comprises communication means (CIE) in the form of network (Wi-Fi, 3G/4G/5G, wired, RFID/NFC, Bluetooth, BLE, LPWan, VLC, etc.) components which allow the device to receive data (I) from entities connected to one or more communication networks and to transmit processed data (T) to such entities.

Such a device comprises, depending on the embodiments:
means for initializing a transaction requiring entry of sensitive data;
means for obtaining, after initialization, through an image pickup device connected to the terminal, multimedia data representative of the user's environment;
means for analyzing the multimedia data previously obtained; and
means for modifying a context of implementation of the transaction when the means for analyzing the multimedia data deliver a result representative of an insecure environment.

As explained previously, these means are implemented via modules and/or components, for example secure. Thus, they ensure the security of transactions carried out while guaranteeing greater maintainability of the device.

1. A method for processing a transaction including a provision, by a user, of sensitive data on a digital terminal, wherein the method is implemented by the digital terminal and comprises:
initializing by the digital terminal, the transaction requiring entry of the sensitive data;
obtaining, after initialization, through an image pickup device connected to the terminal, multimedia data representative of an environment of the user;
analyzing the multimedia data previously obtained; and
modifying an implementation context of the transaction in response to the analyzing of the multimedia data delivering a result representative of an unsecured environment.

2. The method for processing a transaction, according to claim 1, wherein the analyzing comprises:
searching, within the multimedia data, a set of at least one face;
in response to a number of faces being equal to one, searching, within the detected face, an orientation of the eyes of the detected face; and
in response to the orientation of the eyes of the detected face indicating that the user is not looking at a screen of the terminal, providing the result representative of an insecure environment.

3. The method for processing a transaction, according to claim 1, wherein the obtaining comprises, obtaining, from sensors of the digital terminal, at least one data representative of an electric radio environment of the digital terminal; and the analyzing comprises, in response to the data representative of the electric radio environment being not in compliance with an expected value, providing the result representative of an unsecured environment.

4. The method for processing a transaction, according to claim 1, wherein the analyzing comprises:
searching, within the multimedia data, a set of at least one face;
in response to a number of faces being greater than or equal to two, providing the result representative of an insecure environment.

5. The method for processing a transaction, according to claim 2, wherein the analyzing further comprises:
in response to the data representative of the electric radio environment is in compliance with said expected value, searching, within the multimedia data, a set of at least one face.

6. The method for processing a transaction according to claim 4, wherein the modifying an implementation context of the transaction comprises, in response to at least two faces being detected within the multimedia data:
calculating biometric characteristics of at least one among the at least two detected faces; and
updating, within the terminal itself, or a device connected to the terminal, a database of detected face characteristics.

7. The method for processing a transaction according to claim 6, wherein the updating the database of detected face characteristics comprises, a search, within the database, for composite identifiers of facial characteristics corresponding to the characteristics calculated for a current face, and, when such data are already present in the database for the current face, incrementing a counter relating to these characteristics for this current face.

8. The method for processing a transaction according to claim 1, wherein the modifying an implementation context of the transaction comprises:
displaying, to the user, a warning message relating to the detection of the insecure environment;
alerting a terminal manager;
hiding at least one information displayed on a screen of the terminal; and/or
blocking an entry area of the sensitive data.

9. The method for processing a transaction according to claim 7, wherein:
the modifying an implementation context of the transaction comprises:
displaying, to the user, a warning message relating to the detection of the insecure environment;
alerting a terminal manager;
hiding at least one information displayed on a screen of the terminal; and/or
blocking an entry area of the sensitive data; and
the modifying the implementation context of the transaction comprises:
when the data representative of the electric radio environment is not in compliance with an expected value, or when the counter associated with the characteristics calculated for a current face exceeds a predetermined ceiling, performing the alerting of the terminal manager;
when the orientation of the eyes of the detected face indicates that the user is not looking at the terminal screen, or when the number of faces is greater than or equal to two, performing the hiding at least one information displayed on the terminal screen; and
when the number of faces is greater than or equal to two, performing the displaying, to the user, a warning message relating to the detection of the insecure environment and/or the blocking of an entry area of the sensitive data.

10. The method for processing a transaction according to claim 8, subsequent to the displaying of the warning message relating to the detection of the insecure environment, the method comprises, receiving, by the digital terminal, data representative of an acceptance, by the user, of a continuation of the entry of the sensitive data.

11. A digital terminal adapted for processing a transaction comprising a provision, by a user, of sensitive data on the digital terminal, wherein the digital terminal comprises:
at least one processor; and
at least one non-transitory computer readable medium comprising instructions stored thereon which when executed by the at least one processor configure the digital terminal to:
initialize the transaction requiring entry of the sensitive data;
obtain, after initialization of the transaction, through an image pickup device connected to the terminal, multimedia data representative of an environment of the user;
analyze the multimedia data previously obtained; and
modify an implementation context of the transaction in response to the analyzing of the multimedia data delivering a result representative of an unsecured environment.

12. A non-transitory computer readable medium comprising a computer program product stored therein comprising program code instructions for implementing a method for processing a transaction including a provision, by a user, of sensitive data on a digital terminal, when the instructions are executed by a processor of the digital terminal, wherein the method comprises:
initializing by the digital terminal, the transaction requiring entry of the sensitive data;
obtaining, after initialization, through an image pickup device connected to the terminal, multimedia data representative of an environment of the user;
analyzing the multimedia data previously obtained; and
modifying an implementation context of the transaction in response to the analyzing of the multimedia data delivering a result representative of an unsecured environment.
